(19) United States
(12) Patent Application Publication
(10) Pub. No.: US 2009/0047946 A1
(43) Pub. Date: Feb. 19, 2009

(54) MOBILE COMMUNICATION COMPOSITE TERMINAL APPARATUS AND MOBILE COMMUNICATION TERMINAL APPARATUS

(75) Inventors: Mitsuru Sato, Kanagawa (JP); Yoshiyuki Hoshi, Kanagawa (JP); Tomohiro Matano, Kanagawa (JP)

Correspondence Address: Christensen O'Connor Johnson Kindness PLLC, 1420 5th Avenue, Suite 2800, Seattle, WA, 98101, US

(73) Assignee: MATSUSHITA ELECTRIC INDUSTRIAL CO., LTD., Kadoma-shi, Osaka (JP)

(21) Appl. No.: 12/066,649

(22) PCT Filed: Mar. 3, 2006
(86) PCT No.: PCT/JP2006/304174

§ 371 Date: Mar. 12, 2008

(30) Foreign Application Priority Data
Sep. 16, 2005 (JP) 2005-269816

(51) Int. Cl. H04W 48/00; H04W 4/12

(52) U.S. Cl. 455/426.1; 370/338

(57) ABSTRACT

A terminal apparatus that selects, from among a plurality of communication modules, a communication module, which is useful to the user, without increasing current consumption and starts communication in a short time. In this apparatus, which includes a cellular communication module (210) for performing cellular communication and a WLAN communication module (220) for performing WLAN communication, the WLAN communication module (220) is activated by a user operation performed prior to the starting of communication, thereby preferentially performing the connection to a WLAN communication system. There is also included a mail size determining circuit (233) or an activated module selecting circuit (410) as a communication module selecting means for deciding, from the content of the user operation, to select one of the cellular communication module (210) and WLAN communication module (220) that has a useful communication format to the user. There is further included a communication control part (230) that controls the communication module in such a manner that activates only the communication module having the communication format selected by the communication module selecting means, thereby starting communication.

### TECHNICAL FIELD

The present invention relates to a mobile communication composite terminal apparatus and mobile communication terminal apparatus. More particularly, the present invention relates to a dual mode compatible mobile communication composite terminal apparatus and mobile communication terminal apparatus capable of communicating in a plurality of communication schemes.

### BACKGROUND ART

Conventionally, as this type of mobile communication composite terminal apparatus and mobile communication terminal apparatus, there is known dual terminal communication equipment having a plurality of communication control sections corresponding to a plurality of wireless communication systems and a man-machine interface control section that transfers data to/from these communication control sections (e.g., see Patent Document 1).

In the dual terminal communication equipment disclosed in Patent Document 1, the man-machine interface control section is internally provided with a plurality of communication management sections that transfer data to/from the plurality of communication control sections and a switching section that switches between these communication management sections.

This dual terminal communication equipment selects an appropriate communication system from among the plurality of communication systems according to the purpose of use through user's key operations. The communication systems are switched by a switching task.

That is, operation information inputted from a key matrix by the user is transmitted to an MMI sequence of the man-machine interface control section. In the MMI sequence, operation information inputted by the user is transmitted to the switching task and the switching task switches between AIR managers. When the AIR managers are switched, the selected AIR sequence is switched, and, as a result, the system is switched to the user-selected communication system.

Patent Document 1: Japanese Patent Application Laid-Open No. HEI11-331012

### DISCLOSURE OF INVENTION

### Problems to be Solved by the Invention

However, upon selecting an appropriate communication system from among the plurality of wireless communication systems, the conventional mobile communication composite terminal apparatus and mobile communication terminal apparatus need to keep the respective wireless communication systems active all the time, which involves a problem that current consumption increases.

Furthermore, the conventional mobile communication composite terminal apparatus and mobile communication terminal apparatus select an appropriate communication system from among the plurality of wireless communication systems and then check a radio condition of the selected communication system, which involves a problem that it takes time until a communication is started and current consumption further increases.

It is therefore an object of the present invention to provide a mobile communication composite terminal apparatus and mobile communication terminal apparatus capable of selecting a communication module useful for a user from among a plurality of communication modules and starting communication in a short time without increasing current consumption.

### Means for Solving the Problem

The mobile communication composite terminal apparatus according to the present invention employs a configuration having: a first communication module that carries out communication according to a first communication scheme; and a second communication module that carries out communication according to a second communication scheme, and in the mobile communication composite terminal apparatus, the second communication module includes a WLAN communication module that communicates via a WLAN access point, and preferentially activates the WLAN communication module before the communication starts and scans the WLAN access point.

Furthermore, the mobile communication terminal apparatus according to the present invention employs a configuration having: a first communication module that carries out communication according to a first communication scheme; and a second communication module that carries out communication according to a second communication scheme; a communication module selection section that selects a communication module according to a communication scheme useful for a user out of the first communication module and the second communication module according to content of user operation carried out before the communication starts; and a communication control section that controls the communication modules so that only the communication module according to the communication scheme selected by the communication module selection section is activated to start the communication.

### ADVANTAGEOUS EFFECT OF THE INVENTION

According to the present invention, a communication module selection section selects a communication module according to a communication scheme useful for the user before the communication starts, and so, upon selecting a communication module, the communication module need not be activated, so that it is possible to suppress current consumption. Furthermore, only the communication module selected by the communication module selection section is activated by the communication control section before the communication starts, so that it is possible to start the communication in a short time without increasing current consumption.

### BRIEF DESCRIPTION OF DRAWINGS

FIG. 1 is a schematic configuration diagram of a communication system in which a mobile communication terminal apparatus according to Embodiment 1 of the present invention carries out communication;

FIG. 2 is a block diagram showing a configuration of main components of the mobile communication terminal apparatus according to Embodiment 1 of the present invention;

FIG. 3 is a flowchart showing an operation of the mobile communication terminal apparatus according to Embodiment 1 of the present invention;

FIG. 4 is a block diagram showing a configuration of main components of a mobile communication terminal apparatus according to Embodiment 2 of the present invention; and

FIG. 5 is a flowchart showing an operation of the mobile communication terminal apparatus according to Embodiment 2 of the present invention.

### BEST MODE FOR CARRYING OUT THE INVENTION

Embodiments of the present invention will be explained below in detail with reference to the accompanying drawings. In the drawings, components or corresponding parts having the same configurations or functions will be assigned the same reference numerals and explanations thereof will not be repeated.

### Embodiment 1

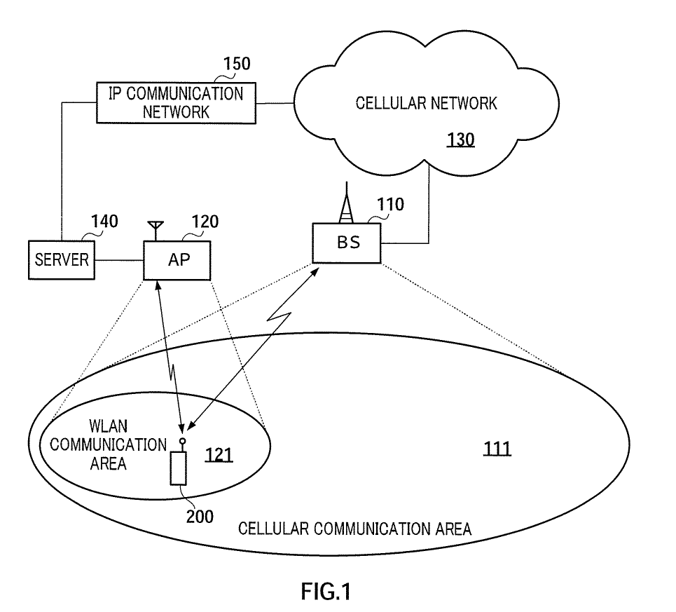

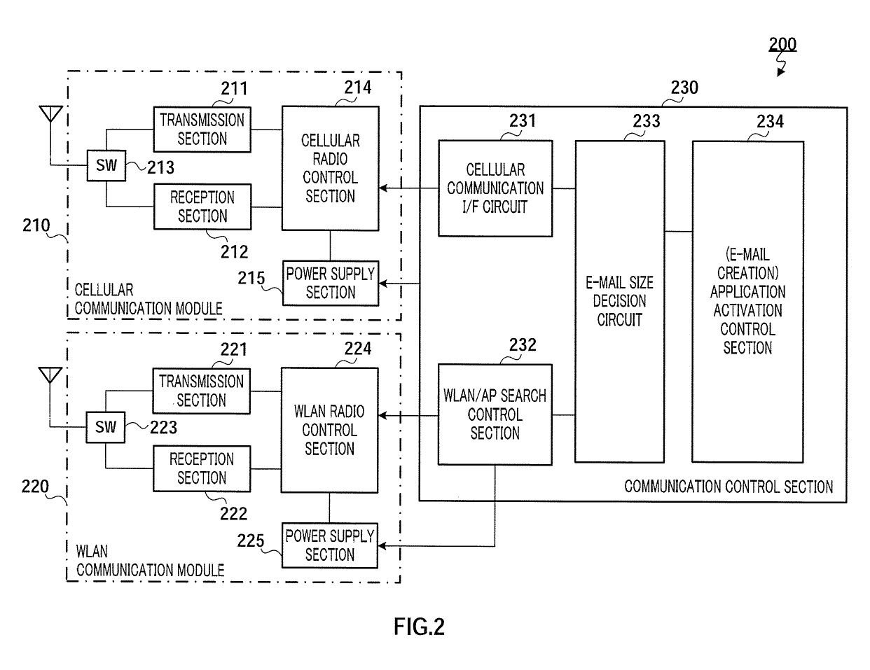

First, before explaining the mobile communication terminal apparatus according to Embodiment 1 of the present invention, the configuration of a communication system in which the mobile communication terminal apparatus of the present embodiment carries out communication will be explained. FIG. 1 is a schematic configuration diagram of the communication system in which the mobile communication terminal apparatus according to Embodiment 1 of the present invention carries out communication. FIG. 2 is a block diagram showing the configuration of main components of the mobile communication terminal apparatus according to Embodiment 1 of the present invention.

As shown in FIG. 1, this communication system is provided with cellular communication area 111 which is a communication area of base station (BS) 110 and WLAN (Wireless Local Area Network) communication area (hot spot) 121 which is a communication area of access point (AP) 120.

As shown in FIG. 2, mobile communication terminal apparatus 200 of the present embodiment is provided with cellular communication module 210 that can communicate in cellular communication area 111 and WLAN communication module 220 that can communicate in WLAN communication area 121.

In FIG. 1, cellular communication module 210 of mobile communication terminal apparatus 200 communicates with a communication terminal which is a communicating party existing in cellular network 130 by cellular radio such as a CDMA (Code Division Multiple Access) scheme and PDC (Personal Digital Cellular) scheme through base station 110 of cellular communication area 111.

Furthermore, WLAN communication module 220 of mobile communication terminal apparatus 200 communicates with a communication terminal of a communicating party existing in IP communication network 150 and cellular network 130 through IP communications based on VoIP (Voice over Internet Protocol) and SIP (Session Initiation Protocol) via access point 120 of WLAN communication area 121 and server 140 as a communication management apparatus.

Next, the configuration of mobile communication terminal apparatus 200 of the present embodiment will be explained with reference to FIG. 2.

As shown in FIG. 2, mobile communication terminal apparatus 200 of the present embodiment is provided with cellular communication module 210, WLAN communication module 220 and communication control section 230.

Cellular communication module 210 includes transmission section 211, reception section 212, transmission/reception changeover switch (SW) 213, cellular radio control section 214 and power supply section 215.

Cellular communication module 210 is activated when power supply section 215 is turned on according to a command from communication control section 230, and transmission section 211 and reception section 212 communicate with base station 110 in cellular communication area 111 as a radio section controlled by cellular radio control section 214 through transmission/reception changeover switch 213.

WLAN communication module 220 includes transmission section 221, reception section 222, transmission/reception changeover switch (SW) 223, WLAN radio control section 224 and power supply section 225.

WLAN communication module 220 is activated when power supply section 225 is turned on according to a command from communication control section 230, and transmission section 221 and reception section 222 communicate with access point 120 in WLAN communication area 121 as a radio section controlled by WLAN radio control section 224 through transmission/reception changeover switch 223.

Communication control section 230 is provided with cellular communication I/F (interface) circuit 231, WLAN/AP search control section 232, e-mail size decision circuit 233 and application activation control section 234.

Application activation control section 234 activates an e-mail creation application and controls creation of transmission e-mail by the user.

E-mail size decision circuit 233 decides whether or not the size (data bit value) of transmission e-mail created by the user is equal to or greater than predetermined threshold Ms.

Here, threshold Ms is a value which serves as criteria for deciding which is more useful for the user, sending transmission e-mail using cellular communication module 210 or sending it using WLAN communication module 220.

Therefore, this threshold Ms is preferably set individually depending on the specification and performance of the communication terminal by comprehensively judging a communication fee required to transmit transmission e-mail created by the user, communication speed (required time) and current consumption or the like.

When e-mail size decision circuit 233 decides that the size of transmission e-mail created by the user is equal to or greater than threshold Ms, a WLAN/AP search circuit (not shown) of WLAN/AP search control section 232 is activated to execute a search (AP search) for access point 120 in WLAN communication area 121.

When accessible access point 120 is searched by this AP search, WLAN/AP search control section 232 turns on power supply section 225 of WLAN communication module 220 and activates WLAN communication module 220, and WLAN communication module 220 can thereby send e-mail.

On the other hand, when e-mail decision circuit 233 decides that the size of transmission e-mail created by the user is less than threshold Ms, communication control section 230 turns on power supply section 215 and activates cellular communication module 210, and cellular communication module 210 can thereby send e-mail through cellular communication I/F circuit 231.

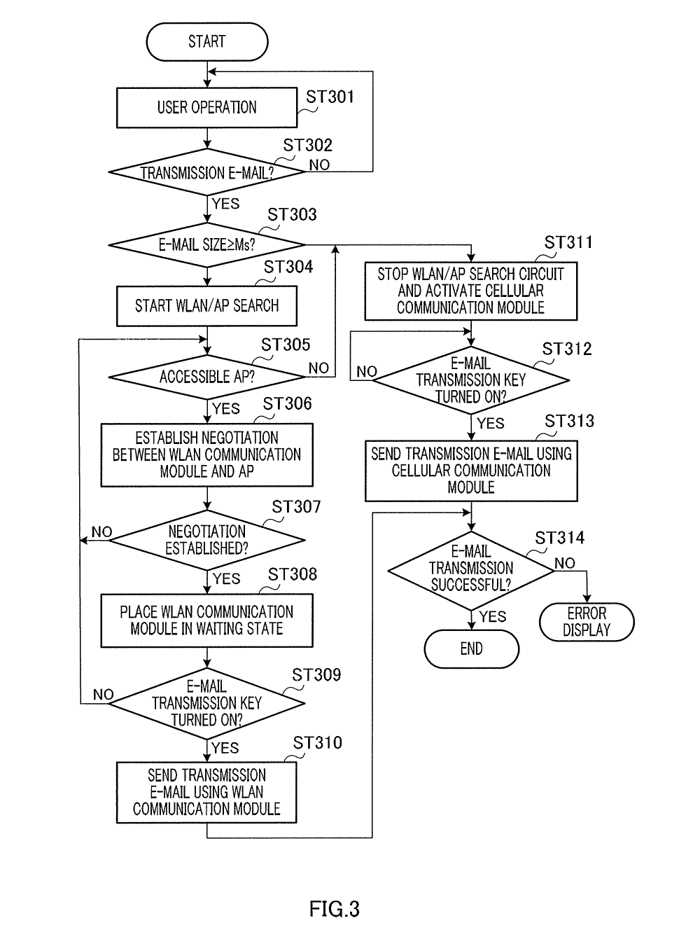

Next, the operation of mobile communication terminal apparatus 200 of the present embodiment will be explained with reference to FIG. 3. FIG. 3 is a flowchart showing the operation of the mobile communication terminal apparatus according to Embodiment 1 of the present invention.

In FIG. 3, when the operation of mobile communication terminal apparatus 200 of the present embodiment starts and some user operation is carried out (step ST301), the presence/absence of transmission e-mail created by the user is decided (step ST302). Here, it is assumed that application activation control section 234 activates an e-mail creation application and the user creates transmission e-mail. Furthermore, cellular communication module 210 is in a waiting state and WLAN communication module 220 is in a halted state.

When it is decided in step ST302 that there is no transmission e-mail, the flow returns to step ST301 to continue the user operation, whereas, when it is decided in step ST302 that there is transmission e-mail, e-mail size decision circuit 233 decides whether or not the size of transmission e-mail is equal to or greater than threshold Ms (step ST303).

Here, when it is decided that the size of transmission e-mail is equal to or greater than threshold Ms, the WLAN/AP search circuit of WLAN/AP search control section 232 is activated to start an AP search in WLAN communication area 121 (step ST304).

It is then decided by this AP search whether or not there is any accessible access point (AP) (step ST305). When accessible access point 120 is searched in step ST305, an operation of establishing negotiation is performed between WLAN communication module 220 and access point 120 (step ST306).

Next, it is decided whether or not negotiation has been established between WLAN communication module 220 and access point 120 (step ST307), and, when negotiation has not been established, the flow returns to step ST305, whereas, when negotiation has been established, WLAN communication module 220 is placed in a waiting state (step ST308).

Next, it is decided whether or not the user has pressed the e-mail transmission key to turn it on (step ST309), and, when the e-mail transmission key has not been turned on, the flow returns to step ST305, whereas, when the e-mail transmission key has been turned on, WLAN communication module 220 is started to send transmission e-mail (step ST310).

On the other hand, when it is decided in step ST303 that the e-mail size of transmission e-mail is less than threshold Ms and it is decided in step ST305 that there is no accessible access point (AP), the WLAN/AP search circuit of WLAN/AP search control section 232 is stopped and cellular communication module 210 is activated (step ST311).

Next, it is decided whether or not the user has pressed the e-mail transmission key to turn it on (step ST312), and, after the e-mail transmission key is turned on, cellular communication module 210 sends transmission e-mail (step ST313).

After the transmission e-mail is sent, it is decided in step ST314 whether or not the e-mail transmission has been successful, and the operation is finished when the e-mail transmission has been successful, and an error is displayed when the e-mail transmission has not been successful.

As described above, in mobile communication terminal apparatus 200 of the present embodiment, e-mail size decision circuit 233 as a communication module selection section selects a communication module according to a communication scheme useful for the user before transmission e-mail is sent (communication starts).

For example, when the e-mail size of transmission e-mail having an attached file such as image or moving image is equal to or greater than threshold Ms, WLAN communication module 220 capable of transmitting at a relatively low-priced fixed fee is selected before e-mail is sent.

Therefore, upon selecting a communication module, mobile communication terminal apparatus 200 according to the present embodiment need not activate cellular communication module 210 and WLAN communication module 220, so that it is possible to suppress current consumption.

Furthermore, in mobile communication terminal apparatus 200 of the present embodiment, communication control section 230 as a communication control section activates only a communication module selected by e-mail size decision circuit 233 as the communication module selection section before communication starts, so that it is possible to start a communication in a short time without increasing current consumption.

### Embodiment 2

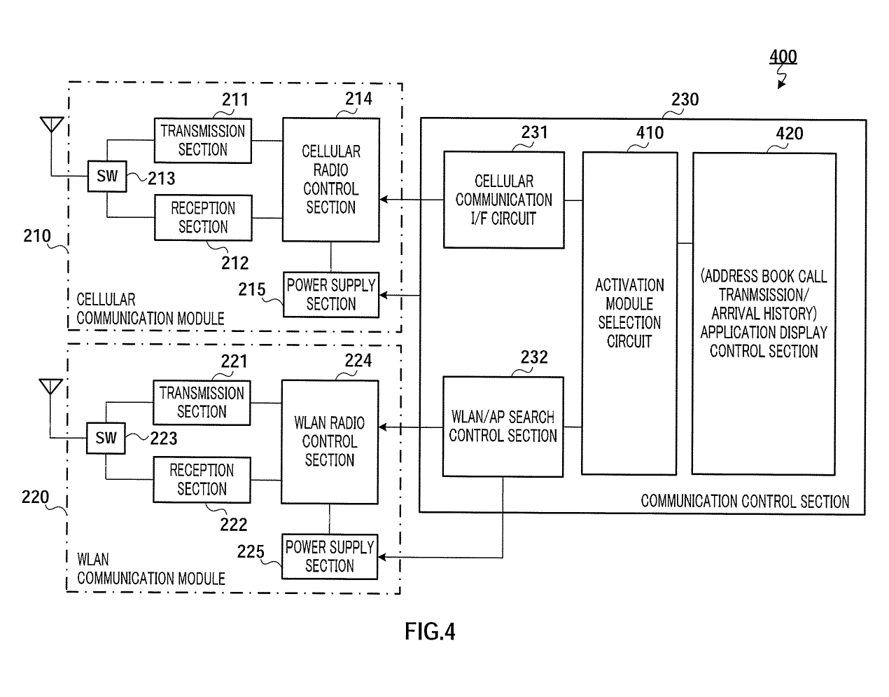

Next, the configuration of mobile communication terminal apparatus 400 according to Embodiment 2 will be explained with reference to FIG. 4.

As shown in FIG. 4, mobile communication terminal apparatus 400 according to the present embodiment has a configuration with e-mail size decision circuit 233 of communication control section 230 in mobile communication terminal apparatus 200 according to Embodiment 1 shown in FIG. 2 replaced by activation module selection circuit 410 and application activation control section 234 of communication control section 230 in mobile communication terminal apparatus 200 replaced by application display control section 420.

That is, communication control section 230 of mobile communication terminal apparatus 400 according to this embodiment is provided with activation module selection circuit 410 and application display control section 420.

In FIG. 4, when application display control section 420 is activated and an address book or call transmission/arrival history is displayed on a display section (not shown) of mobile communication terminal apparatus 400, activation module selection circuit 410 selects activation of WLAN communication module 220.

That is, user's action of displaying an address book or call transmission/arrival history stored in a memory as a storage section (not shown) on a display section means that a call is started with the communicating party of the address displayed by the user or telephone number in the call transmission/arrival history.

Therefore, mobile communication terminal apparatus 400 according to the present embodiment selects a call using WLAN communication module 220 which is a low-cost of a call and useful for a user before a start of conversation with the communicating party.

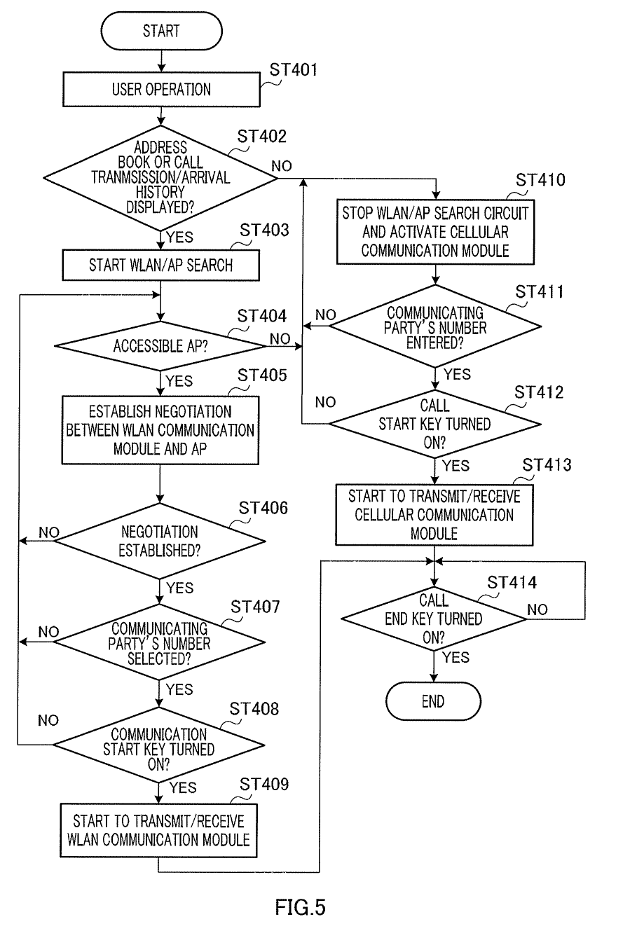

Next, the operation of mobile communication terminal apparatus 400 of the present embodiment will be explained with reference to FIG. 5. FIG. 5 is a flowchart showing the operation of the mobile communication terminal apparatus according to Embodiment 2 of the present invention.

In FIG. 5, when the operation of mobile communication terminal apparatus 200 of this embodiment starts and some user operation is carried out (step ST401), it is decided whether or not the address book or call transmission/arrival history stored in the memory is displayed on the display section of mobile communication terminal apparatus 400 (step ST402). At this time point, cellular communication module 210 is in a waiting state and WLAN communication module 220 is in a halted state.

In step ST402, when the address book or call transmission/arrival history stored in the memory is displayed on the display section of mobile communication terminal apparatus 400, the WLAN/AP search circuit of WLAN/AP search control section 232 is activated to start an AP search of WLAN communication area 121 (step ST403). It is then decided through this AP search whether or not there is an accessible access point (AP) (step ST404).

In step ST404, when accessible access point 120 is searched, an operation to establish negotiation between WLAN communication module 220 and access point 120 is executed (step ST405).

Next, it is decided whether or not the negotiation between WLAN communication module 220 and access point 120 has been established (step ST406), and, when negotiation has not been established, the flow returns to step ST404, whereas, when negotiation has been established, it is decided whether or not communicating party's number (telephone number) has been selected from the address book or call transmission/arrival history displayed on the display section of mobile communication terminal apparatus 400 (step ST407).

Here, when communicating party's number has not been selected, the flow returns to step ST404, whereas, when communicating party's number has been selected, it is decided whether or not the user has pressed the call start key to turn it on (step ST408).

In step ST408, when the call start key has not been turned on, the flow returns to step ST404, whereas, when the call start key has been turned on, WLAN communication module 220 is started to start transmission/reception (call) to/from the communicating party (step ST409).

On the other hand, in step ST402, when the address book or call transmission/arrival history has not been displayed on the display section and when it is decided in step ST404 that there is no accessible access point (AP), the WLAN/AP search circuit of WLAN/AP search control section 232 is stopped and cellular communication module 210 is activated (step ST410).

After that, it is decided whether or not the user has entered communicating party's number (step ST411), and, when no number has been entered, the flow returns to step ST410, whereas, when communicating party's number has been entered, it is decided whether or not the call start key has been pressed to turn it on (step ST412).

In step ST412, when the call start key has not been turned on, the flow returns to step ST410, whereas, when the call start key has been turned on, cellular communication module 210 starts transmission/reception (call) to/from the communicating party (step ST413).

After that, it is decided whether or not the user has turned on the call end key (step ST414), and, when the user has turned on the call end key, the operation ends.

As described above, in mobile communication terminal apparatus 400 of the present embodiment, activation module selection circuit 410 as a communication module selection section selects a communication module according to a communication scheme useful for the user before a call with the communicating party starts (communication starts).

Therefore, upon selecting a communication module, mobile communication terminal apparatus 400 of the present embodiment need not activate cellular communication module 210 and WLAN communication module 220, so that it is possible to suppress current consumption.

Furthermore, in mobile communication terminal apparatus 400 of the present embodiment, communication control section 230 as a communication control section activates only the communication module selected by activation module selection circuit 410 as a communication module selection section before communication starts, so that it is possible to start communication in a short time without increasing current consumption.

Although a case has been described with the present embodiment where mobile communication terminal apparatus 400 preferentially or automatically selects WLAN communication module 220 according to a low-cost IP communication scheme for the user before communication starts, the user can finally select a communication module for communication at user's discretion. By this means, upon carrying out communication while the user is moving at high speed by car or the like, the user can select cellular communication module 210 capable of stable communication at user's discretion instead of WLAN communication module 220 which may lose the communication because access point 120 is frequently switched.

The present application is based on Japanese Patent Application No. 2005-269816, filed on Sep. 16, 2005, entire content of which is expressly incorporated by reference herein.

### INDUSTRIAL APPLICABILITY

Upon selecting a communication module, the mobile communication terminal apparatus according to the present invention need not activate a communication module, can suppress current consumption, activate only the selected communication module before starting the communication and start the communication in a short time without increasing current consumption, so that the mobile communication terminal apparatus is useful as a dual mode compatible mobile communication terminal apparatus capable of communicating under a plurality of communication schemes.

1. A mobile communication composite terminal apparatus comprising:
a first communication module that carries out communication according to a first communication scheme; and
a second communication module that carries out communication according to a second communication scheme,
wherein the second communication module comprises a wireless local area network communication module that communicates via a wireless local area network access point, and preferentially activates the wireless local area network communication module before the communication starts and scans the wireless local area network access point.

2. A mobile communication terminal apparatus comprising:
a first communication module that carries out communication according to a first communication scheme; and
a second communication module that carries out communication according to a second communication scheme;
a communication module selection section that selects a communication module according to a communication scheme useful for a user out of the first communication module and the second communication module according to content of user operation carried out before the communication starts; and
a communication control section that controls the communication modules so that only the communication module according to the communication scheme selected by the communication module selection section is activated to start the communication.

3. The mobile communication terminal apparatus according to claim 2, wherein:
the first communication module comprises a cellular communication module that communicates through a base station of a cellular communication network;
the second communication module comprises a wireless local area network communication module that communicates through the wireless local area network access point; and
the communication control section executes an operation of searching the wireless local area network access point before the communication starts when the communication module selection section selects the wireless local area network communication module, activates only the wireless local area network communication module when there is an accessible access point, and stops the operation of searching the access point and activates the cellular communication module when there is no accessible access point.

4. The mobile communication terminal apparatus according to claim 3, further comprising an e-mail function that transmits transmission e-mail created by user operation to a communication terminal of e-mail destination specified by the user, wherein the communication module selection section decides whether or not the e-mail size of the transmission e-mail is equal to or greater than a predetermined threshold before transmission of the transmission e-mail starts, and selects the wireless local area network communication module when the e-mail size is equal to or greater than the threshold, and selects the cellular communication module when the e-mail size is less than the threshold.

5. The mobile communication terminal apparatus according to claim 3, further comprising an address book function that stores an address book describing an address of a communicating party of communication in a storage section and displays the address book stored in the storage section through user operation on a display section,
wherein the communication module selection section decides whether or not the address book is displayed on the display section before a communication starts, and selects the wireless local area network communication module when the address book is displayed on the display section, and selects the cellular communication module when the address book is not displayed on the display section.

6. The mobile communication terminal apparatus according to claim 3, comprising a call transmission/arrival history display function that stores a call transmission/arrival history of a communicating party of communication in a storage section and displays the call transmission/arrival history stored in the storage section on a display section through user operation,
wherein the communication module selection section decides whether or not the call transmission/arrival history has been displayed on the display section before a communication starts, selects the wireless local area network communication module when the call transmission/arrival history is displayed on the display section, and selects the cellular communication module when the call transmission/arrival history is not displayed on the display section.
